(19) United States
(12) Patent Application Publication
(10) Pub. No.: US 2025/0097025 A1
(43) Pub. Date: Mar. 20, 2025

(54) PARAMETER GENERATION DEVICE, PARAMETER GENERATION METHOD AND COMPUTER READABLE MEDIUM

(71) Applicant: Mitsubishi Electric Corporation, Tokyo (JP)

(72) Inventor: Kenichiro HAYASAKA, Tokyo (JP)

(73) Assignee: Mitsubishi Electric Corporation, Tokyo (JP)

(21) Appl. No.: 18/964,247

(22) Filed: Nov. 29, 2024

Related U.S. Application Data
(63) Continuation of application No. PCT/JP2022/027557, filed on Jul. 13, 2022.

(51) Int. Cl. H04L 9/08; H04L 9/30

(52) U.S. Cl. CPC H04L 9/0869; H04L 9/3073

(57) ABSTRACT

A parameter generation device generates a seed. A preliminary calculation unit calculates a composite number condition under which a first integer and a second integer obtained by substituting an integer into each of a first polynomial p(x) and a second polynomial r(x) is a composite number. A seed candidate generation unit searches for an integer of which a Hamming weight in a signed binary representation is included in a weight range (W). The seed candidate generation unit deletes an integer that satisfies the composite number condition from a set of integers obtained by search, to obtain a set of seed candidates (T). A prime number decision unit extracts, from the set T, integers for which both of a first polynomial and a second polynomial become prime numbers when the integers are substituted into the first polynomial and the second polynomial, and regards the integers as a set (S).

### CROSS REFERENCE TO RELATED APPLICATION

This application is a Continuation of PCT International Application No. PCT/JP2022/027557, filed on Jul. 13, 2022, which is hereby expressly incorporated by reference into the present application.

### TECHNICAL FIELD

The present disclosure relates to a parameter generation device, a parameter generation method and a parameter generation program. Especially, the present disclosure relates to a parameter generation device, a parameter generation method and a parameter generation program to generate a parameter in pairing computation.

### BACKGROUND ART

Pairing computation is an arithmetic operation used in encryption methods rich in functions such as searchable encryption and attribute-based encryption. The paring computation is largely divided into computation of Miller function and computation of exponentiations on a finite field. In the following, the former is called the Miller loop, and the latter is called final exponentiation. Computations of the Miller loop and the final exponentiation require complicated computation processes. Optimization of both computations is necessary for encryption methods using pairing computation.

An elliptic curve used in pairing computation is selected from a family of elliptic curves suitable for the pairing computation. The family of elliptic curves is also called pairing-friendly curves. As the pairing-friendly curves, BN curves, BLS curves and KSS curves are known, for instance. BN is an abbreviation for Barreto-Naehrig. BLS is an abbreviation for Barreto-Lynn-Scott. KSS is an abbreviation for Kachisa-Schaefer-Scott. In Non-Patent Literature 1, an elliptic curve corresponding to 256-bit security level is selected from BLS 27 curves.

The pairing-friendly curve is constituted of a polynomial p(x), a polynomial r(x), a polynomial t(x) and an embedding degree K. An elliptic curve E used in the pairing computation is an elliptic curve defined on a finite field Fp with the number of elements p=p(u). r=r(u) is the largest prime number to divide the order of a group E(Fp). t=t(u) is the trace of the elliptic curve E. In this case, k is the smallest positive integer satisfying (p\hat{ }k−1)=0 (mod r).

As described, the elliptic curve used in pairing computation is selected by determining an integer u. This integer u is also called a seed. However, it is necessary that the integer p and the integer r are prime numbers, and the integer r has a size that satisfies a specified security level.

The integer u has a large influence on computational complexity of pairing computation. More specifically, the smaller the number of digits in a signed binary representation and the Hamming weight of the integer u are, the smaller the computational complexity is. Meanwhile, there is a case where the fewer the digits of −1 in the signed binary representation of the integer u are, the smaller the computational complexity is depending on the pairing computation algorithm.

Non-Patent Literature 2 makes reference to a generation method of parameters suitable for pairing computation.

### CITATION LIST

### Patent Literature

Non-Patent Literature 1: X. Zhang, D. Lin, “Analysis of Optimum Pairing Products at High Security Levels”, INDOCRYPT 2012, pp. 412-430, 2012
Non-Patent Literature 2: S. Duquesne, N. El Mrabet, S. Haloui and F. Rondepierre, “Choosing and generating parameters for pairing implementation on BN curves”, Algebra Eng. Commun. Comput., vol. 29, pp. 113-147, 2018

### SUMMARY OF INVENTION

### Technical Problem

In Non-Patent Literature 1, an elliptic curve corresponding to 256-bit security level is selected from BLS27 curves.

Further, in Non-Patent Literature 2, as an integer u, an integer whose Hamming weight is specified s, and which satisfies a specified condition cond, is selected from a specified range. Furthermore, it is confirmed that an integer p=p(u) and an integer r=r(u) are prime numbers with respect to the integer u selected. However, the specified condition cond under which the integer u is selected is a condition to improve efficiency of computation on the finite field. Further, there is no reference to a generation method of the integer u with the Haming weight being a specified value h. Additionally, since signed binary representations of an integer are not uniquely specified in general, by the parameter generation method of Non-Patent Literature 2, there occurs duplication in integers u to be generated.

As described, since the probability of an integer u randomly selected satisfying all conditions is not high, there exists a problem that a lot of time is spent in searching for an integer u being one of the parameters in pairing computation.

The present disclosure is aimed at generating an appropriate seed in a short time by efficiently searching for a seed suitable for pairing computation.

### Solution to Problem

There is provided according to the present disclosure a parameter generation device to generate a seed being a parameter to determine an elliptic curve used for paring computation, the parameter generation device includes
a preliminary calculation unit to calculate, as a composite number condition, a condition of an integer under which at least either of a first integer and a second integer obtained by substituting an integer into each of a first polynomial and a second polynomial that constitute an elliptic curve family from which the elliptic curve is selected is a composite number;
a seed candidate generation unit to search for an integer whereof a Hamming weight in a signed binary representation represented in a non-adjacent form is included in a weight range defined beforehand, to delete an integer that satisfies the composite number condition from a set of integers obtained by search, and to regard a set of remaining integers obtained by deleting the integer that satisfies the composite number condition as a set of seed candidates; and
a prime number decision unit to decide whether both of the first polynomial and the second polynomial become prime numbers when each integer of the set of seed candidates is substituted into the first polynomial and the second polynomial, and to extract an integer for which both of the first polynomial and the second polynomial become prime numbers, from the set of seed candidates, as the seed.

### Advantageous Effects of Invention

In a parameter generation device according to the present disclosure, a preliminary calculation unit calculates, as a composite number condition, a condition of an integer under which at least either of a first integer and a second integer obtained by substituting an integer into each of a first polynomial and a second polynomial that constitute a family of elliptic curves is a composite number. A seed candidate generation unit searches for an integer whose Hamming weight of a signed binary representation represented in a non-adjacent form is included in a weight range. Then, the seed candidate generation unit deletes integers satisfying the composite number condition from a set of integers obtained by search, to make a set of seed candidates. Therefore, by the parameter generation device according to the present disclosure, there is an effect that a seed suitable for pairing computation can be efficiently searched for, and an appropriate seed can be generated in a short time.

### BRIEF DESCRIPTION OF DRAWINGS

FIG. 1 is a diagram illustrating an example of a functional configuration of a parameter generation device according to a first embodiment;

FIG. 2 is a flow diagram illustrating an operation of a preliminary calculation unit according to the first embodiment;

FIG. 3 is a flow diagram illustrating an operation of a seed candidate generation unit according to the first embodiment;

FIG. 4 is a flow diagram illustrating an operation of a prime number decision unit according to the first embodiment;

FIG. 5 is a flow diagram illustrating an operation of a seed representation generation unit according to the first embodiment;

FIG. 6 is a diagram illustrating an example of a hardware configuration of the parameter generation device according to the first embodiment; and

FIG. 7 is a diagram illustrating an example of a hardware configuration of a parameter generation device 10 according to a variation of the first embodiment.

### DESCRIPTION OF EMBODIMENTS

Hereinafter, description will be made on a present embodiment using diagrams. In the drawings, the same or the corresponding elements are denoted by the same reference signs. In description of the embodiment, explanation of the same or the corresponding elements is appropriately omitted or simplified. The arrows in the diagrams mainly represent flows of data or processing.

### First Embodiment

A parameter generation device 10 according to the present embodiment generates a seed being a parameter to determine an elliptic curve used in pairing computation.

The seed to be searched for may be called an integer u in the present embodiment.

### ***Description of Configuration***

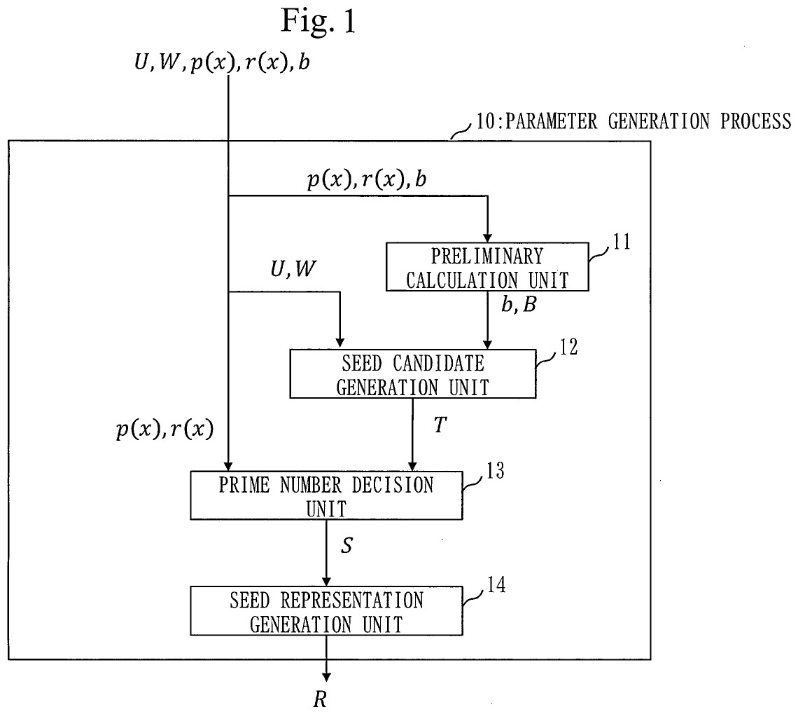

FIG. 1 is a diagram illustrating an example of a functional configuration of the parameter generation device 10 according to the present embodiment.

The parameter generation device 10 includes, as functional elements, a preliminary calculation unit 11, a seed candidate generation unit 12, a prime number decision unit 13 and a seed representation generation unit 14.

Herein, description will be made mainly on input and output of each functional element.

The parameter generation device 10 accepts a search range U, a weight range W, a polynomial p(x), a polynomial r(x) and a threshold value b.

The search range U is a range to search for an integer u, i.e., a seed.

The weight range W is a range of a Hamming weight of an integer in the non-adjacent form. In the present embodiment, a Hamming weight of an integer a in the non-adjacent form is denoted by HW (NAF(a)).

The polynomial p(x) and the polynomial r(x) are polynomials to constitute a family of elliptic curves from which an elliptic curve is selected. Details will be described later.

The threshold value b is a threshold value of prime numbers.

The preliminary calculation unit 11 receives the polynomial p(x), the polynomial r(x) and the threshold value b being elements to constitute a pairing-friendly curve. Then, the preliminary calculation unit 11 outputs the threshold value b and a set B generated, to the seed candidate generation unit 12.

The seed candidate generation unit 12 receives the search range U for the integer u and the weight range W of the Hamming weight. Further, the seed candidate generation unit 12 uses the threshold value b and the set B being outputs from the preliminary calculation unit 11, as inputs. Then, the seed candidate generation unit 12 outputs a set T of candidates of the integer u generated, to the prime number decision unit 13.

The prime number decision unit 13 receives the polynomial p(x) and the polynomial r(x). Further, the prime number decision unit 13 uses the set T being the output from the seed candidate generation unit 12, as an input. Then, the prime number decision unit 13 outputs a set S of integers u such that both of the integer p(u) and the integer r(u) are prime numbers, to the seed representation generation unit 14.

The seed representation generation unit 14 uses the set S being the output from the prime number decision unit 13, as an input. Then, the seed representation generation unit 14 calculates a set R of representations of integers u suitable for pairing computation, and transmits the set R.

Herein, description will be made on the integer u being the seed generated in the present embodiment, signed binary representations of the integer, and a non-adjacent form among the signed binary representations.

As described above, the elliptic curve used in pairing computation is selected from among the family of elliptic curves suitable for pairing computation. Hereinafter, description will be made by referring to the family of elliptic curves as pairing-friendly curves.

A pairing-friendly curve is constituted of a polynomial p(x), a polynomial r(x), a polynomial t(x) and an embedding degree K. An elliptic curve E used in pairing computation is an elliptic curve defined over a finite field Fp with the number of elements p=p(u). r=r(u) is the largest prime number to divide the order of a group E(Fp). t=t(u) is the trace of the elliptic curve E. Herein, k is the smallest positive integer satisfying (p\hat{ }k−1)=0 (mod r).

As described, the elliptic curve used in pairing computation is selected by determining the integer u. However, it is necessary that the integer p and the integer r are prime numbers, and the integer r has a size that satisfies a specified security level.

The integer u has a large influence on computational complexity of pairing computation. More specifically, the smaller the number of digits in a signed binary representation and the Hamming weight of the integer u are, the smaller the computational complexity is. In addition, there is a case where the fewer the digits of −1 in a signed binary representation of the integer u are, the smaller the computational complexity is.

A signed binary representation of an integer a shall indicate a binary representation allowing −1. Further, the Hamming weight of the integer a shall indicate the number of non-zero digits in a signed binary representation of the integer a. For example, 198 in the decimal number system can be represented as (11000110)₂ in the binary number system. Herein, when n is used as a digit of −1, (11001n10)₂, for instance, is one of the signed binary representations of 198, and the Hamming weight is 5.

There exists a non-adjacent form (NAF) as a representation method included in signed binary representations. Generally, the signed binary representations of the integer a are not uniquely specified. However, the non-adjacent form of the integer a has features that it is uniquely specified, and the Hamming weight is minimal. For example, the non-adjacent form of 198 in the decimal system is (10n0010n0)₂, and the Hamming weight is 4.

### ***Description of Operation***

Next, description will be made on an operation of the parameter generation device 10 according to the present embodiment. The operation procedure of the parameter generation device 10 corresponds to a parameter generation method. Further, a program to realize the operation of the parameter generation device 10 corresponds to a parameter generation program.

Description will be made on the operation of the parameter generation device 10 according to the present embodiment using FIG. 1.

In order to implement pairing computation, the prime number p and the prime number r are necessary as parameters. The prime number p and the prime number r are generated by substituting the integer u into the polynomial p(x) and the polynomial r(x) being elements of the paring-friendly curve. Therefore, it is necessary to fix the integer u.

However, it is preferable for the integer u to be such that, for the polynomial p(x) and the polynomial r(x), both of the integer p(u) and the integer r(u) are prime numbers, and the Hamming weight of the integer u is small. The condition that both of the integer p(u) and the integer r(u) are prime numbers shall be a condition 1. Meanwhile, the condition that the Hamming weight of the integer u is small shall be a condition 2.

For the polynomial p(x) and the polynomial r(x), it is necessary that the integer u being the seed satisfies the condition 1 and the condition 2.

The condition 1 is a condition necessary for pairing computation to be established. Further, the condition 2 is a condition to implement pairing computation efficiently.

If an integer u is randomly selected, in many cases, the probability of the condition 1 or the condition 2 being satisfied is remarkably low. Therefore, in the present embodiment, by selecting only integers u with higher probabilities of the condition 1 or the condition 2 being satisfied, the efficiency of search process for the integer u is improved.

First, an integer that satisfies the condition 2, i.e., the condition that the Hamming weight of the integer is small, is generated by using the non-adjacent form. As described above, in general, since signed binary representations are not specified uniquely, there occurs duplication in integers u that satisfy the condition 2, and the search time is increased. Meanwhile, the non-adjacent form among signed binary representations is uniquely specified with respect to an integer. Therefore, it is easy to confirm whether the condition 2 is satisfied since it is possible to minimize the search range for the integer u, and the Hamming weight is minimal.

Next, in order to improve the probability of satisfying the condition 1, i.e., the condition that both of the integer p(u) and the integer r(u) are prime numbers, a condition of the integer u under which the integer p(u) or the integer r(u) has a small prime factor is calculated beforehand.

For example, when an integer a such that p(a)=0 (mod q) exists for a certain prime number q, it is apparent that p(u)=0 (mod q) if u=a (mod q).

When the root of p(x) mod q and the root of r(x) mod q are calculated beforehand for several prime numbers q, and an integer u is congruent with a root in accordance with q as a modulus, the integer u is deleted from candidates for search. In this manner, it is possible to confirm existence of the prime factor q by division to calculate a remainder for the integer u prior to deciding whether p(u) or r(u) is a prime number. Further, it may be applicable to add, as a pair of this prime number q and the root, a condition to improve efficiency of computation on the finite field as in Non-Patent Literature 2.

In addition, it may be applicable to use sieve processing using elements of a set B for deletion of an integer u from candidates for search. For example, when a prime number q and a root a of a polynomial f (x) mod q are obtained, f (a) has a prime factor q. Further, f(a+mq) for an integer m also has a prime factor q. In this manner, when the integer u is congruent with the root a in accordance with q as the modulus, it is possible to delete (u+mq) from the candidates for search without performing division to calculate a remainder.

When a non-adjacent form is used as a signed-binary representation of the integer u, the Hamming weight is minimal, and it is possible to improve efficiency of pairing computation. However, the non-adjacent form cannot always make the computational complexity of paring computation be minimal. For example, when the integer u is 198 in the decimal system, the non-adjacent form of u is (10n0010n0)₂, and the Hamming weight is 4.

Herein, as for (110010n0)₂ being one of the signed-binary representations of u, the Hamming weight is 4 as well, and the number of digits is smaller by 1 than the non-adjacent form.

Further, similarly as for (11000110)₂ being one of the signed-binary representations of u, the Hamming weight is 4, and it is represented only by digits of 0 and 1. It is possible to reduce the computational complexity of pairing computation more by using the signed-binary representation indicated last rather than the non-adjacent form.

In the preliminary calculation unit 11, roots of the first polynomial p(x) and the second polynomial r(x) are calculated for a prime number q equal to or less than the threshold value b, and a set B of pairs of q and the root is generated.

In the seed candidate generation unit 12, an integer u of which the Hamming weight in the non-adjacent form is included in the weight range W is searched for in the search range U, and a set T is generated. Further, an integer u that does not satisfy the condition 1 is deleted from the set T by referring to the set B.

In the prime number decision unit 13, whether both of the integer p(u) and the integer r(u) are prime numbers is decided for an integer u being an element of the set T, and a set S of integers u for which the decision result is true is generated.

In the seed representation generation unit 14, a signed-binary representation v such that efficiency of pairing computation is improved is calculated for each element u of the set S, and a set R of pairs (u, v) is generated.

### <Preliminary Calculation Process>

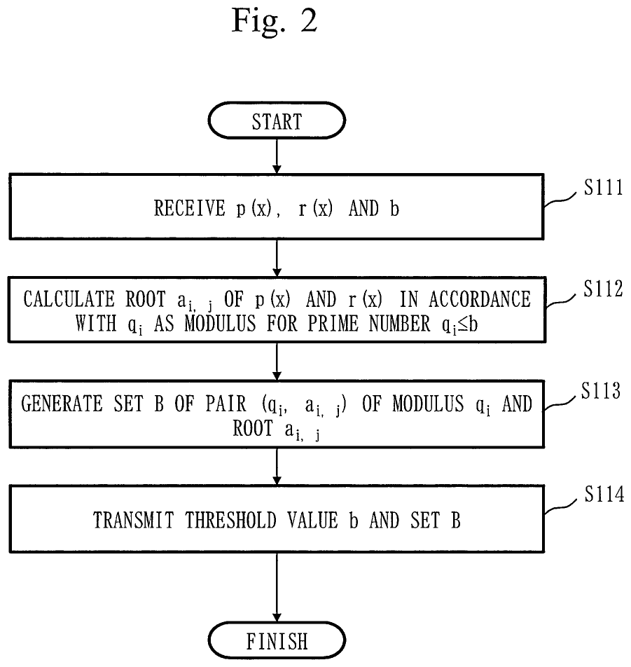

FIG. 2 is a flow diagram illustrating an operation of the preliminary calculation unit 11 according to the present embodiment.

Description will be made on a preliminary calculation process according to the present embodiment based on FIG. 2.

In the preliminary calculation process, the preliminary calculation unit 11 calculates, as a composite number condition, a condition of an integer under which at least either of a first integer p and a second integer r obtained by substituting an integer into each of the first polynomial p(x) and the second polynomial r(x) that constitute a family of elliptic curves from which an elliptic curve is selected is a composite number.

Specifically, the preliminary calculation unit 11 calculates roots of p(x) mod q and r(x) mod q for a prime number q equal to or less than the threshold value b. Then, the preliminary calculation unit 11 generates a set B of pairs of q, and a root a being the root of p(x) mod q or r(x) mod q, as the composite number condition.

More specifically as follows.

In Step S111, the preliminary calculation unit 11 receives the first polynomial p(x), the second polynomial r(x) and the threshold value b.

In Step S112, the preliminary calculation unit 11 calculates a root a_{i, j} of the polynomial p(x) and the polynomial r(x) in accordance with qᵢ as a modulus for a prime number qᵢ equal to or less than the threshold value b. The root a_{i, j} is a root of p(x) mod q or r(x) mod q. In this case, the subscripts i and j may be natural numbers, or integers equal to or more than 0. i represents the number of prime numbers, and j represents the number of roots aᵢ corresponding to each prime number qᵢ.

In Step S113, the preliminary calculation unit 11 generates a set B of pairs (qᵢ, a_{i, j}) calculated, as the composite number condition.

In Step S114, the preliminary calculation unit 11 transmits the threshold value b and the set B to the seed candidate generation unit 12.

### <Seed Candidate Generation Process>

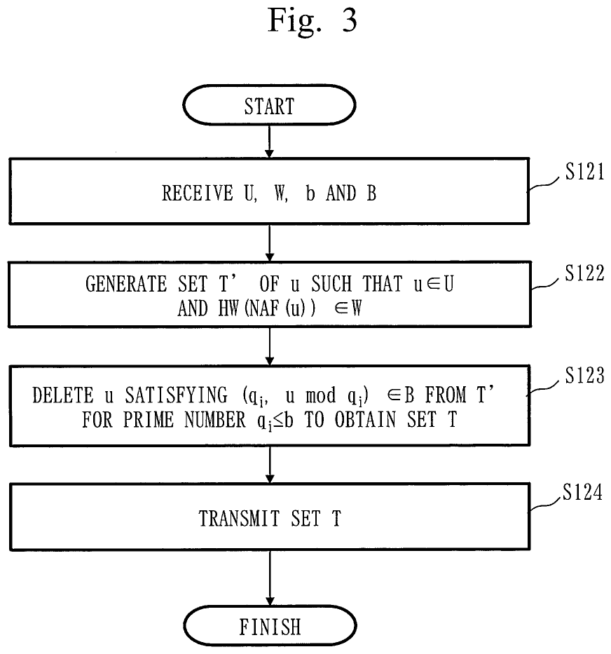

FIG. 3 is a flow diagram illustrating an operation of the seed candidate generation unit 12 according to the present embodiment.

Description will be made on a seed candidate generation process according to the present embodiment based on FIG. 3.

In the seed candidate generation process, the seed candidate generation unit 12 searches for an integer of which the Hamming weight in a signed-binary representation represented in the non-adjacent form is included in the weight range W determined beforehand. Then, the seed candidate generation unit 12 deletes an integer that satisfies the composite number condition from a set T′ of integers obtained by search. Then, the seed candidate generation unit 12 regards a set of remaining integers obtained by deleting the integer that satisfies the composite number condition, as the set T of seed candidates.

Specifically, the seed candidate generation unit generates a pair of a prime number q and u mod q for an integer u of the set T′ of integers obtained by search. Then, when the pair of the prime number q and u mod q is included in the set B being the composite number condition, the seed candidate generation unit deletes the integer u from the set T′ of integers obtained by search.

That an integer u satisfies the composite number condition means that the integer u is congruent with the root a in accordance with q as the modulus.

More specifically as follows.

In Step S121, the seed candidate generation unit 12 receives the search range U for the integer u, the weight range W being the range of Hamming weight, the threshold value b and the set B.

In Step S122, the seed candidate generation unit 12 searches in the search range U for an integer of which the Hamming weight in the non-adjacent form is included in the weight range W, and generates the set T′ of integers obtained.

In Step S123, the seed candidate generation unit 12 calculates a pair (qi, u mod qi) for each element u of the set T′ and a prime number qi equal to or less than the threshold value b. Then, the seed candidate generation unit 12 regards the set T′ from which an integer u for which the pair (qi, u mod qi) is included in the set B is deleted, as a set T of seed candidates.

In Step S124, the seed candidate generation unit 12 transmits the set T to the prime number decision unit 13.

### <Prime Number Decision Process>

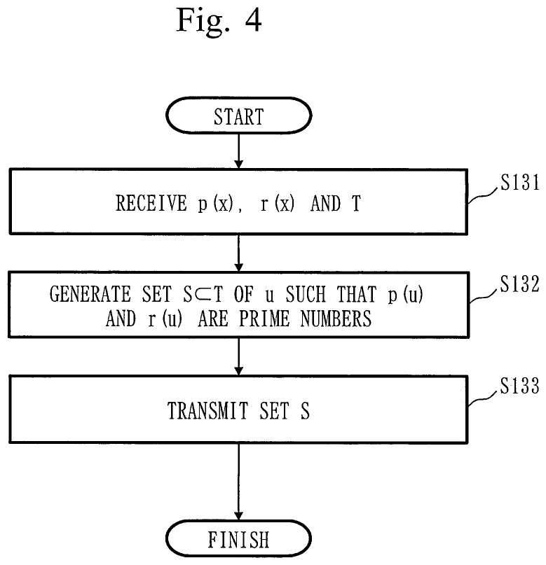

FIG. 4 is a flow diagram illustrating an operation of the prime number decision unit 13 according to the present embodiment.

Description will be made on a prime number decision process according to the present embodiment based on FIG. 4.

In the prime number decision process, the prime number decision unit 13 decides whether both of the first polynomial p(u) and the second polynomial r(u) become prime numbers when each integer u of the set T of seed candidates is substituted into the first polynomial p(u) and the second polynomial r(u). The prime number decision unit 13 extracts an integer u for which both of the first polynomial p(u) and the second polynomial r(u) are prime numbers, from the set T of seed candidates, as a seed.

Specifically as follows.

In Step S131, the prime number decision unit 13 receives the first polynomial p(x), the second polynomial r(x) and the set T of seed candidates.

In Step S132, the prime number decision unit 13 decides whether both of the integer p=p(u) and the integer r=r(u) are prime numbers for each element u of the set T, and generates a set S of integers u such that the decision result is true.

In Step S133, the prime number decision unit 13 transmits the set S to the seed representation generation unit 14.

### <Seed Representation Generation Process>

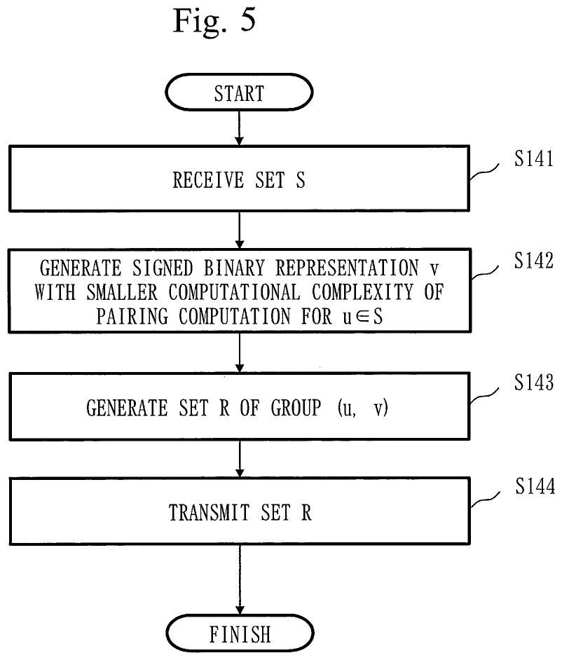

FIG. 5 is a flow diagram illustrating an operation of the seed representation generation unit 14 according to the present embodiment.

Description will be made on a seed representation generation process according to the present embodiment based on FIG. 5.

In the seed representation generation process, the seed representation generation unit 14 represents a seed in a signed-binary representation for which the computational complexity of pairing computation is smaller than the computational complexity for a non-adjacent form.

Specifically as follows.

In Step S141, the seed representation generation unit 14 receives the set S.

In Step S142, the seed representation generation unit 14 generates a signed-binary representation v for which the computational complexity of pairing computation becomes smaller with respect to each element u of the set S. It is preferable for the seed representation generation unit 14 to generate a signed-binary representation v for which the computational complexity of pairing computation is the smallest with respect to each element u of the set S.

In Step S143, the seed representation generation unit 14 generates a set R of the pair (u, v) generated.

In Step S144, the seed representation generation unit 14 transmits the set R.

### Description of Effect of Present Embodiment

As described above, in the present embodiment, an effective search method for an integer u suitable for pairing computation is introduced. Specifically, in the parameter generation device according to the present embodiment, duplication in integers u is eliminated, and efficiency in search is improved by using a non-adjacent form in which representation is uniquely specified as a signed binary representation. Further, in the parameter generation device according to the present embodiment, a list of x such that the integer p=p(x) and the integer r=r(x) have small prime factors is generated. Then, the parameter generation device according to the present embodiment reduces the computational complexity of parameter search by removing elements of the list from the search range for the integer u.

Thus, by the parameter generation device according to the present embodiment, it is possible to eliminate duplication in integers u and improve efficiency in search by generating an integer u with a specified Hamming weight using the non-adjacent form. Further, by the parameter generation device according to the present embodiment, it is possible to reduce the computational complexity for deciding a prime number by replacing decision on whether the integer p or the integer r has a small prime factor with decision by division to calculate a remainder for the integer u. Furthermore, by the parameter generation device according to the present embodiment, it is possible to reduce the computational complexity of pairing computation by generating a singed-binary representation which is converted without changing the Hamming weight from the non-adjacent form of the integer u.

### ***Description of Example of Hardware Configuration***

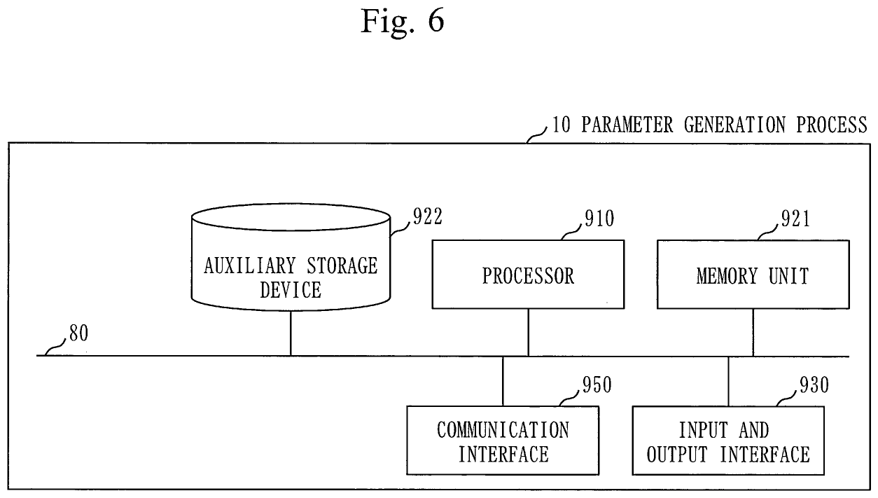

FIG. 6 is a diagram illustrating an example of a hardware configuration of the parameter generation device 10 according to the present embodiment.

The parameter generation device 10 is a computer. The parameter generation device 10 includes a processor 910, and further includes other hardware components such as a memory unit 921, an auxiliary storage device 922, an input and output interface 930 and a communication interface 950. The processor 910 is connected to other hardware components via a signal line 80, and controls these other hardware components.

As described above, the parameter generation device 10 includes the preliminary calculation unit 11, the seed candidate generation unit 12, the prime number decision unit 13 and the seed representation generation unit 14 as functional components. The functions of the preliminary calculation unit 11, the seed candidate generation unit 12, the prime number decision unit 13 and the seed representation generation unit 14 are realized by software.

Hereinafter, the preliminary calculation unit 11, the seed candidate generation unit 12, the prime number decision unit 13 and the seed representation generation unit 14 may be called each unit of the parameter generation device 10.

The processor 910 is a device to execute the parameter generation program. The parameter generation program is a program to realize the functions of the parameter generation device 10.

The processor 910 is an IC to perform arithmetic processing. A concrete example of the processor 910 is a CPU, a DSP or a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory unit 921 is a storage device to store data temporarily. A concrete example of the memory unit 921 is an SRAM or a DRAM. SRAM is an abbreviation for Static Random Access Memory. DRAM is an abbreviation for Dynamic Random Access Memory.

The auxiliary storage device 922 is a storage device to store data. A concrete example of the auxiliary storage device 922 is an HDD. Further, the auxiliary storage device 922 may be a portable storage medium such as an SD (registered trademark) memory card, a CF, a NAND flash, a flexible disk, an optical disk, a compact disk, a Blue-ray (registered trademark) disk, or a DVD. HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input and output interface 930 is an interface to connect to input and output devices. The input and output interface 930 is a USB port or an HDMI (registered trademark) port for example. USB is an abbreviation for Universal Serial Bus. HDMI (registered trademark) is an abbreviation for High-Definition Multimedia Interface.

The communication interface 950 is an interface to communicate with external devices. The communication interface 950 is an Ethernet (registered trademark) port or a device to perform wireless communication for example.

The parameter generation program is executed in the parameter generation device 10. The parameter generation program is read into the processor 910, and is executed by the processor 910. The memory unit 921 stores not only the parameter generation program but also an OS. OS is an abbreviation for Operating System. The processor 910 executes the parameter generation program while executing the OS. The parameter generation program and the OS may be stored in the auxiliary storage device 922. The parameter generation program and the OS stored in the auxiliary storage device 922 are loaded into the memory unit 921, and executed by the processor 910. A part or the whole of the parameter generation program may be incorporated in the OS.

The parameter generation device 10 may include a plurality of processors to replace the processor 910. The plurality of processors share execution of the parameter generation program. Each processor is a device to execute the parameter generation program in the same way as the processor 910.

The data, information, signal values and variable values used, processed or output by the parameter generation program are stored in the memory unit 921, the auxiliary storage device 922 or a register or a cache memory device inside the processor 910.

“Unit” of the preliminary calculation unit 11, the seed candidate generation unit 12, the prime number decision unit 13 and the seed representation generation unit 14 may be replaced with “circuit”, “step”, “procedure”, “process” or “circuitry”. The parameter generation program causes a computer to execute a preliminary calculation process, a seed candidate generation process, a prime number decision process and a seed representation generation process. The “process” of the preliminary calculation process, the seed candidate generation process, the prime number decision process and the seed representation generation process may be replaced with “program”, “program product”, “a computer-readable storage medium in which a program is stored” or “a computer-readable recording medium in which a program is recorded”. Further, the parameter generation method is a method performed by executing the parameter generation program by the parameter generation device 10.

The parameter generation program may be provided by being stored in a computer-readable recording medium. Further, the parameter generation program may be provided as a program product.

### Other Configurations

### <Variation>

In the present embodiment, the functions of the preliminary calculation unit 11, the seed candidate generation unit 12, the prime number decision unit 13 and the seed representation generation unit 14 are realized by software. As a variation, the functions of the preliminary calculation unit 11, the seed candidate generation unit 12, the prime number decision unit 13 and the seed representation generation unit 14 may be realized by hardware.

Specifically, the parameter generation device 10 includes an electronic circuit 909 in place of the processor 910.

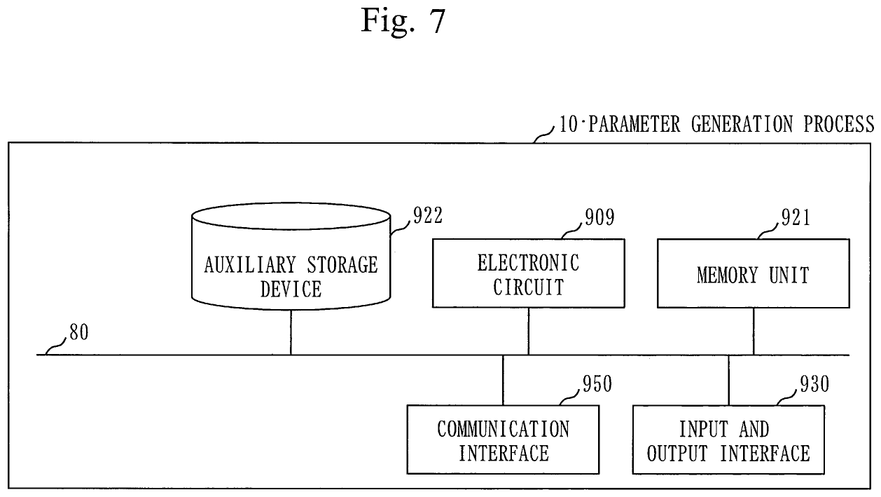

FIG. 7 is a diagram illustrating an example of hardware configuration of the parameter generation device 10 according to the variation of the present embodiment.

The electronic circuit 909 is a dedicated electronic circuit to realize the functions of each unit of the parameter generation device 10. The electronic circuit 909 is, for example, a single a single circuit, a composite circuit, a programmed processor, a parallel-programmed processor, a logic IC, a GA, an ASIC or an FPGA. GA is an abbreviation for Gate Array. ASIC is an abbreviation for Application Specific Integrated Circuit. FPGA is an abbreviation for Field-Programmable Gate Array.

The functions of each unit of the parameter generation device 10 may be realized by one electronic circuit, or may be realized by a plurality of electronic circuits dispersedly.

As another variation, a part of the functions of each unit of the parameter generation device 10 may be realized by an electronic circuit, and the remaining functions may be realized by software. Further, a part or all of the functions of each unit of the parameter generation device 10 may be realized by firmware.

Each of the processors and electronic circuits is also called processing circuitry. That is, the functions of each unit of the parameter generation device 10 are realized by processing circuitry.

In First Embodiment above, description has been made on each unit of the parameter generation device 10 as an independent functional block. However, the parameter generation device 10 does not have to be configured as in the embodiment above. The functional blocks of the parameter generation device 10 may be configured in any manner if only the functional blocks can realize the functions described in the embodiment above. Further, the parameter generation device 10 may be a system configured by a plurality of devices, not by one device.

Furthermore, a plurality of parts of First Embodiment may be combined and performed. Otherwise, a part of the embodiment may be performed. In addition, the embodiment may be combined and performed totally or partially in any manner of combination.

That is, in First Embodiment, it is possible to freely combine each embodiment, to deform an arbitrary component of each embodiment, or to omit an arbitrary component in each embodiment.

The embodiment as described above is an essentially preferable example, and is not intended for limiting the scope of the present disclosure, the range of application of the present disclosure, and the range of use of the present disclosure. It is possible to variously change the embodiment described above as needed. For example, the procedures described using the flow diagrams and the sequence diagram may be changed appropriately.

### REFERENCE SIGNS LIST

parameter generation device; 11: preliminary calculation unit; 12: seed candidate generation unit; 13: prime number decision unit; 14: seed representation generation unit; U: search range; W: weight range; b: threshold value; T, B, S, R: set; 80: signal line; 909: electronic circuit; 910: processor; 921: memory unit; 922: auxiliary storage device; 930: input and output interface; 950: communication interface.

1. A parameter generation device to generate a seed being a parameter to determine an elliptic curve used for paring computation, the parameter generation device comprising:
processing circuitry
to calculate, as a composite number condition, a condition of an integer under which at least either of a first integer and a second integer obtained by substituting an integer into each of a first polynomial and a second polynomial that constitute an elliptic curve family from which the elliptic curve is selected is a composite number;
to search for an integer whereof a Hamming weight in a signed binary representation represented in a non-adjacent form is included in a weight range defined beforehand, to delete an integer that satisfies the composite number condition from a set of integers obtained by search, and to regard a set of remaining integers obtained by deleting the integer that satisfies the composite number condition as a set of seed candidates; and
to decide whether both of the first polynomial and the second polynomial become prime numbers when each integer of the set of seed candidates is substituted into the first polynomial and the second polynomial, and to extract an integer for which both of the first polynomial and the second polynomial become prime numbers, from the set of seed candidates, as the seed.

2. The parameter generation device as defined in claim 1, wherein the processing circuitry represents the seed in a signed binary representation for which computational complexity of the pairing computation is smaller than that for the non-adjacent form.

3. The parameter generation device as defined in claim 1, wherein
the processing circuitry calculates a root a being a root of p(x) mod q or r(x) mod q, for p(x) being the first polynomial, r(x) being the second polynomial and a prime number q, and regards a pair of the prime number q and the root a as the composite number condition, and
the processing circuitry generates a pair of the prime number q and u mod q for the integer u of the set of integers obtained by the search, and deletes an integer u from the set of integers obtained by the search when the pair of the prime number q and u mod q is included in the composite number condition.

4. The parameter generation device as defined in claim 3, wherein
the processing circuitry receives a threshold value defined beforehand, and calculates a root a being a root of p(x) mod q or r(x) mod q for p(x), r(x) and a prime number q equal to or less than the threshold value, and
the processing circuitry generates a pair of the prime number q equal to or less than the threshold value, and u mod q.

5. The parameter generation device as defined in claim 1, wherein the processing circuitry receives a range to search for the seed as a search range, and searches for an integer whereof the Hamming weight is included in the weight range, in the search range.

6. The parameter generation device as defined in claim 1, wherein the processing circuitry receives the weight range, and searches for an integer whereof the Hamming weight is included in the weight range.

7. A parameter generation method to be used by a parameter generation device to generate a seed being a parameter to determine an elliptic curve used for paring computation, the parameter generation method comprising:
calculating, as a composite number condition, a condition of an integer under which at least either of a first integer and a second integer obtained by substituting an integer into each of a first polynomial and a second polynomial that constitute an elliptic curve family from which the elliptic curve is selected is a composite number;
searching for an integer whereof a Hamming weight in a signed binary representation represented in a non-adjacent form is included in a weight range defined beforehand, deleting an integer that satisfies the composite number condition from a set of integers obtained by search, and regarding a set of remaining integers obtained by deleting the integer that satisfies the composite number condition as a set of seed candidates; and
deciding whether both of the first polynomial and the second polynomial become prime numbers when each integer of the set of seed candidates is substituted into the first polynomial and the second polynomial, and extracting an integer for which both of the first polynomial and the second polynomial become prime numbers, from the set of seed candidates, as the seed.

8. A non-transitory computer readable medium storing a parameter generation program to be used by a parameter generation device to generate a seed being a parameter to determine an elliptic curve used for paring computation, the parameter generation program causing a computer to perform:
a preliminary calculation process to calculate, as a composite number condition, a condition of an integer under which at least either of a first integer and a second integer obtained by substituting an integer into each of a first polynomial and a second polynomial that constitute an elliptic curve family from which the elliptic curve is selected is a composite number;
a seed candidate generation process to search for an integer whereof a Hamming weight in a signed binary representation represented in a non-adjacent form is included in a weight range defined beforehand, to delete an integer that satisfies the composite number condition from a set of integers obtained by search, and to regard a set of remaining integers obtained by deleting the integer that satisfies the composite number condition as a set of seed candidates; and
a prime number decision process to decide whether both of the first polynomial and the second polynomial become prime numbers when each integer of the set of seed candidates is substituted into the first polynomial and the second polynomial, and to extract an integer for which both of the first polynomial and the second polynomial become prime numbers, from the set of seed candidates, as the seed.
